(19) United States
(12) Patent Application Publication
(10) Pub. No.: US 2006/0023003 A1
(43) Pub. Date: Feb. 2, 2006

(54) Color display apparatus

(75) Inventor: Kazuya Yamanaka, Hachioji-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/170,807

(22) Filed: Jun. 30, 2005

(30) Foreign Application Priority Data
Jul. 30, 2004 (JP) 2004-224666

(51) Int. Cl. G09G 5/10

(52) U.S. Cl. 345/690

(57) ABSTRACT

A color display apparatus includes a display section which sequentially displays a plurality of sub-frame images in a plurality of colors based on the input image information to emit projection light, a ray position control section which controls a ray position of the projection light emitted by the display section, in synchronism with display timings for the sub-frame images, and an optical section which presents the viewer with the projection light. The ray position control section performs control such that the number of ray positions of the projection light emitted by each of the pixels of the display section is M (M=2 or M>2) during one-frame period and performs the control for the one-frame period, over N (N=2 or N>2) frame periods, so that rays of the projection light for all the plurality of colors are located at each of the M ray positions.

### CROSS-REFERENCE TO RELATED APPLICATIONS

This application is based upon and claims the benefit of priority from prior Japanese Patent Application No. 2004-224666, filed Jul. 30, 2004, the entire contents of which are incorporated herein by reference.

### BACKGROUND OF THE INVENTION

1. Field of the Invention

The present invention relates to a color display apparatus that can display color images of a high resolution.

2. Description of the Related Art

A color display apparatus based on a field sequential system has been proposed. The color display apparatus based on the field sequential system displays a color image by sequentially displaying an R (red), G (green), and B (blue) images on a monochromatic display device and sequentially supplying R (red), G (green), and B (blue) illumination light to the monochromatic display device in synchronism with the display timing. The color display apparatus based on the field sequential system can display an R, G, and B images at the same display position. Consequently, this color display apparatus can triple the resolution of each color compared to a single-plate type color display apparatus using an R, G, and B color filters.

On the other hand, a wobbling technique is known to accomplish a high resolution using a light modulating device (LCD or the like) with a limited number of pixels; the wobbling technique shifts pixels by combining a polarization rotatable liquid crystal panel with a birefringence plate. The wobbling technique can realize a display apparatus having a resolution at least twice as high as that of the light modulating device, by using the polarization rotatable liquid crystal panel and the birefringence plate to shift the pixels.

Jpn. Pat. Appln. KOKAI Publication No. 2002-281517 proposes a color display apparatus having a combination of the field sequential system and the wobbling technique. In this proposal, R, G, and B images are displayed at the same pixel positions in both frames in which pixels are not shifted and those in which pixels are shifted. Thus, for example, a four-point pixel shift requires a period of four frames. This increases a display period required to display images at all pixel positions using the pixel shift. The above publication also proposes a method of displaying G and R images at the same pixel positions in frames in which pixels are not shifted, while displaying G and B images at the same pixel positions in frames in which pixels are shifted. However, with this method, it is not impossible to display all the colors R, G, and B at each pixel position, and the colors R, G, and B involve different display pitches (resolutions). As a result, what is called false colors may occur.

Jpn. Pat. Appln. KOKAI Publication No. 7-284113 proposes a method used for a CRT having R, G, and B stripes to display R, G, and B images at the same stripe position by the pixel shift. However, this proposal only displays the R, G, and B images at each stripe position. Accordingly, this method does not provide a resolution higher than that determined by the original stripes.

Thus, a problem with the conventional is are that the pixel shift may increase the display period required to display images at all the pixel positions or result in false colors. As a result, it is difficult to obtain color images of a high resolution and high quality.

It is an object of the present invention to provide a color display apparatus that can provide color images of a high resolution and high quality.

### BRIEF SUMMARY OF THE INVENTION

According to a first aspect of the present invention, there is provided a color display apparatus which presents a viewer with a color image based on input image information, the apparatus comprising: a display section which sequentially displays a plurality of sub-frame images in a plurality of colors based on the input image information to emit projection light; a ray position control section which controls a ray position of the projection light emitted by the display section, in synchronism with display timings for the sub-frame images; and an optical section which presents the viewer with the projection light controlled by the ray position control section, wherein the display section emits the projection light for each pixel of the display section on the basis of the input image information, and the ray position control section performs control such that the number of ray positions of the projection light emitted by each of the pixels of the display section is M (M is an integer equal to or greater than 2) during one-frame period and performs the control for the one-frame period, over N (N is an integer equal to or greater than 2) frame periods, so that rays of the projection light for all the plurality of colors are located at each of the M ray positions.

In the color display apparatus, the number M is equal to the number N.

In the color display apparatus, the plurality of colors are red, green, and blue, the number N is 4, and during one-frame period, the display section displays each of a red sub-frame image and a blue sub-frame image once and a green sub-frame image twice.

In the color display apparatus, the green sub-frame images are not consecutively displayed during the one frame period.

In the color display apparatus, the plurality of colors are red, green, and blue, the number N is 2, during one-frame period, the display section displays each of a red sub-frame image and a blue sub-frame image once and a green sub-frame image twice, and the ray position control section controls the ray positions of the projection light so that during the one-frame period, the projection light of the red sub-frame image and the projection light of one of the green sub-frame images are located at the same ray position and the projection light of the blue sub-frame image and the projection light of the other green sub-frame image are located at the same ray position.

In the color display apparatus, the green sub-frame images are not consecutively displayed during the one-frame period.

In the color display apparatus, the plurality of colors are red, green, blue, and white, the number N is 4, and the ray position control section controls the ray positions of the projection light of the red, green, blue, and white sub-frame images emitted by the display section during the one-frame period.

In the color display apparatus, the ray position control section controls the ray positions of the projection light emitted by the display section so that a resolution of an image recognized by the viewer is N times as high as that of the display section itself.

In the color display apparatus, the display section comprises: a white light source which emits white illumination light; a rotatable color filter which sequentially converts the white illumination light emitted by the white light source into illumination light in the plurality of colors; and a light modulating device which modulates the illumination light sequentially emitted by the rotatable color filter on the basis of the input image information.

In the color display apparatus, the display section comprises: a plurality of LED light sources which sequentially emit illumination light in the plurality of colors; and a light modulating device which modulates the illumination light sequentially emitted by the LED light sources on the basis of the input image information.

In the color display apparatus, the ray position control section has a liquid crystal panel which can rotate a direction of polarization of the projection light, and a birefringence plate which generates transmission light shifted from an extension of incident light if the incident light has a particular direction of polarization, and the liquid crystal panel rotates the direction of polarization of the projection light in synchronism with the display timings for the sub-frame images.

According to a second aspect of the present invention, there is provided a color display apparatus which presents a viewer with a color image based on input image information, the apparatus comprising: a display section which sequentially displays a plurality of sub-frame images in a plurality of colors based on the input image information to emit projection light; a ray position control section which controls a ray position of the projection light emitted by the display section, in synchronism with display timings for the sub-frame images; and an optical section which presents the viewer with the projection light controlled by the ray position control section, wherein the display section emits the projection light for each pixel of the display section on the basis of the input image information, and the ray position control section performs control such that the number of ray positions of the projection light emitted by each of the pixels of the display section is M (M is an integer equal to or greater than 2) during one-frame period and such that the number of ray positions of projection light of the sub-frame image in at least one color is twice as large as that of ray positions of projection light of the sub-frame image in the other color, so that rays of the projection light for all the plurality of colors are located at each of the M ray positions.

In the color display apparatus, the ray position control section has a liquid crystal panel which can rotate a direction of polarization of the projection light in synchronism with the display timings for the sub-frame images, and a birefringence plate which generates transmission light shifted from an extension of incident light if the incident light has a particular direction of polarization, and the liquid crystal panel rotates the direction of polarization of the projection light through 45° for the at least one color and maintains the direction of polarization of the projection light or rotates the direction of polarization of the projection light through 90° for the other color.

In the color display apparatus, the display section comprises: a white light source which emits white illumination light; a rotatable color filter which sequentially converts the white illumination light emitted by the white light source into illumination light in the plurality of colors; and a light modulating device which modulates the illumination light sequentially emitted by the rotatable color filter on the basis of the input image information.

In the color display apparatus, the display section comprises: a plurality of LED light sources which sequentially emit illumination light in the plurality of colors, and a light modulating device which modulates the illumination light sequentially emitted by the LED light sources on the basis of the input image information.

In the color display apparatus, the ray position control section has a liquid crystal panel which can rotate a direction of polarization of the projection light, and a birefringence plate which generates transmission light shifted from an extension of incident light if the incident light has a particular direction of polarization, and the liquid crystal panel rotates the direction of polarization of the projection light in synchronism with the display timings for the sub-frame images.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the configuration of a color display apparatus according to a first embodiment of the present invention;

FIG. 2 is a diagram showing an example of the configuration of a color wheel according to the first embodiment of the present invention;

FIG. 3 is a diagram showing a pixel array in a light modulating device according to the first embodiment of the present invention;

FIGS. 4A to 4D are diagrams showing how projection light is displayed on the projection surface according to the first embodiment of the present invention;

FIG. 5 is a diagram showing how projection light is synthetically displayed on the projection surface according to the first embodiment of the present invention;

FIG. 6 is a diagram showing an operation performed by a ray position control section to shift a light ray according to the first embodiment of the present invention;

FIG. 7 is a diagram showing an operation performed by the ray position control section to shift a light ray according to the first embodiment of the present invention;

FIG. 8 is a diagram showing an operation performed by the ray position control section to shift a light ray according to the first embodiment of the present invention;

FIG. 9 is a diagram showing an operation performed by the ray position control section to shift a light ray according to the first embodiment of the present invention;

FIGS. 10A to 10D are diagrams showing how projection light for each frame is synthetically displayed on the projection surface according to the first embodiment of the present invention;

FIG. 11 is a diagram showing the flow of a display operation in a time axis direction according to the first embodiment of the present invention;

FIG. 12 is a block diagram showing the electric configuration of the color display apparatus according to the first embodiment of the present invention;

FIG. 13 is a diagram schematically showing the configuration of a color display apparatus according to a second embodiment of the present invention;

FIG. 14 is a diagram showing the flow of a display operation in the time axis direction according to the second embodiment of the present invention;

FIG. 15 is a diagram schematically showing the configuration of a color display apparatus according to a third embodiment of the present invention;

FIGS. 16A to 16D are diagrams showing how projection light is displayed on the projection surface according to the third embodiment of the present invention;

FIG. 17 is a diagram showing how projection light is synthetically displayed on the projection surface according to the third embodiment of the present invention;

FIG. 18 is a diagram showing an operation performed by the ray position control section to shift a light ray according to the third embodiment of the present invention;

FIG. 19 is a diagram showing an operation performed by the ray position control section to shift a light ray according to the third embodiment of the present invention;

FIG. 20 is a diagram showing the flow of a display operation in the time axis direction according to the third embodiment of the present invention;

FIG. 21 is a diagram schematically showing the configuration of a color display apparatus according to a fourth embodiment of the present invention;

FIGS. 22A to 22D are diagrams showing how projection light is displayed on the projection surface according to the fourth embodiment of the present invention;

FIG. 23 is a diagram showing the flow of a display operation in the time axis direction according to the fourth embodiment of the present invention; and

FIG. 24 is a diagram showing how projection light is synthetically displayed on the projection surface according to a fifth embodiment of the present invention.

### DETAILED DESCRIPTION OF THE INVENTION

Embodiments of the present invention will be described below with reference to the drawings.

### Embodiment 1

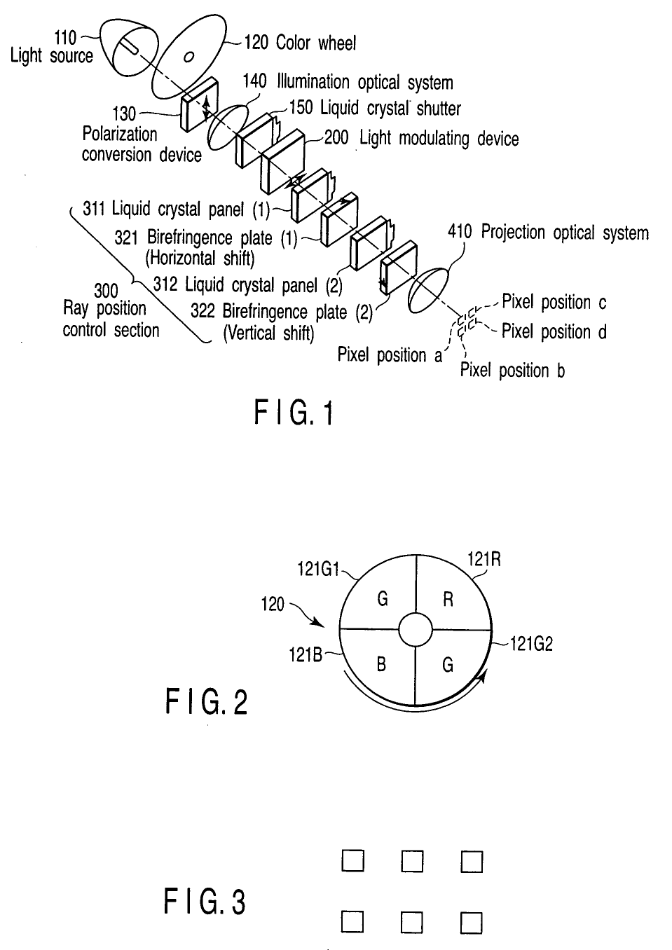

FIG. 1 is a diagram schematically showing a color image projection apparatus (color display apparatus) according to a first embodiment of the present invention.

A light source 110 generates white light and is a discharge lamp (metal halide lamp, ultra-high-pressure mercury lamp, or xenon lamp) or a halogen lamp.

A color wheel 120 is provided on an exit side of the light source 110. As shown in FIG. 2, the color wheel 120 has an R filter section 121R that transmits R (red) light, G filter sections 121G1 and 121G2 that transmit G (green) light, and a B (blue) filter section 121B that transmits B (blue) light. Rotation of the color wheel 120 allows illumination light from the light source 110 to pass sequentially through the G filter section 121G1, the R filter section 121R, the G filter section 121G2, and the B filter section 121B. In the example shown in FIG. 2, the filter sections have an equal area. However, the ratio of the areas of the filter sections may be optimized taking into account the color temperature of the light source 110, white balance, or the like. Alternatively, a light shielding section may be provided at the boundary between the filter sections taking into account the response speeds of a light modulating device 200 and a ray position control section 300 described later.

An exit surface side of the color wheel 120 is provided with a polarization conversion device (PS conversion device 130, an illumination optical system 140, a liquid crystal shutter 150. The polarization conversion device 130 makes light from a light source having no particular polarization direction travel in a particular polarization direction (in the present example, a vertical direction). The polarization conversion device 130 enables a polarization direction to be efficiently set to reduce a loss in the quantity of light. The liquid crystal shutter 150 adjusts the ratio of the quantity of light from the filter sections of the color wheel 120. White balance can be optimized by adjusting the ratio of the quantities of light in the respective colors. Thus, the polarization conversion device 130 and the liquid crystal shutter 150 are arranged in order to improve light utilization efficiency and to optimize white balance. Accordingly, the polarization conversion device 130 and the liquid crystal shutter 150 are not essential to the present invention.

The light modulating device 200 spatially modulates incident light (illumination light) in accordance with image data (video signal). The light modulating device 200 is composed of a transmission LCD using a liquid crystal in a TN (Twisted Nematic) mode. The transmission LCD is a monochromatic light modulating device for which the color of outgoing light is determined depending on the filter section of the color wheel 120. An entrance side of the transmission LCD is provided with a polarization plate (not shown) having a polarization transmission axis extending in the vertical direction. An exit side of the transmission LCD is provided with a polarization plate (not shown) having a polarization transmission axis extending in a horizontal direction. Therefore, outgoing light from the light modulating device 200 is polarization light having a polarization transmission axis extending in the horizontal direction.

Projection light (video light) spatially modulated by the light modulating device 200 is incident on the ray position control section 300. The ray position control section 300 is composed of polarization rotatable liquid crystal panels 311 and 312 that can rotate polarization and birefringence plates 321 and 322 having birefringence.

The liquid crystal panels 311 and 312 are each composed of a liquid crystal panel using a TN liquid crystal. The liquid crystal panels 311 and 312 are each configured to control the rotation of the polarization in response to turn-on and -off of an applied voltage. Specifically, while the application of a voltage to the liquid crystal panel is off, P-polarized light is rotated through 90° to become S-polarized light. S-polarized light is rotated through 90° to become P-polarized light. While the application of a voltage to the liquid crystal panel is on, P-polarized light is not rotated and passes through the liquid crystal panel as it is. Likewise, S-polarized light is not rotated and passes through the liquid crystal panel as it is. A liquid crystal different from the TN liquid crystal may be used for the liquid crystal panels 311 and 312 provided that it can rotate the polarization direction of incident light.

The birefringence plates 321 and 322 are colorless, transparent crystal plates having birefringence. The birefringence plates 321 and 322 tend to separate incident light into ordinary light (no) and extraordinary light (ne) depending on the polarization direction of the incident light. The birefringence plates 321 and 322 can be composed of quartz plates or lithium niobate plates, or the like. The birefringence plate 321 is configured to shift a light ray by a half pixel pitch in the horizontal direction. Polarized light in the vertical direction acts as ordinary light and passes through the birefringence plate 321 without being shifted by it. Polarized light in the horizontal direction acts as extraordinary light and is shifted by the birefringence plate 321 in the horizontal direction. The birefringence plate 322 is configured to shift a light ray by a half pixel pitch in the vertical direction. Polarized light in the horizontal direction acts as ordinary light and passes through the birefringence plate 322 without being shifted by it. Polarized light in the vertical direction acts as extraordinary light and is shifted by the birefringence plate 322 in the vertical direction. The amount of shift can be determined by the material and thickness of the birefringence plates.

Projection light from the ray position control section 300 is projected on a screen (not shown) via a projection optical system 410. The projection light projected on the screen is recognized by the viewer as an image.

Since the ray position control section 300 is configured as described above, the shift state of the projection light incident on the ray position control section 300 is controlled according to the on and off states (four states) of polarization rotatable liquid crystal panels 311 and 312. As a result, depending on the shift state of projection light, a light ray of the projection light reaches a pixel position a, b, c, or d on the screen.

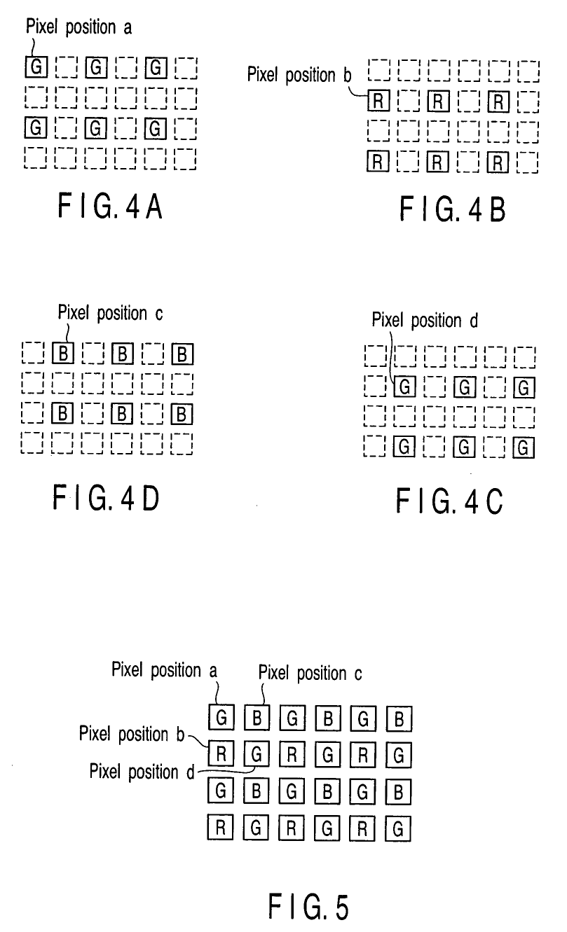

FIG. 3 is a diagram showing the arrangement of pixels in the transmission LCD constituting the light modulating device 200. FIGS. 4A to 4D are diagrams showing a display state on a projection surface (screen surface) on which the projection light is projected, the display state varying depending on the shift state controlled by the ray position control section 300.

In the present embodiment, one frame is divided into a first to fourth sub-frames. The process described below is used to establish the display state shown in FIG. 4A in the first sub-frame, the display state shown in FIG. 4B in the second sub-frame, the display state shown in FIG. 4C in the third sub-frame, and the display state shown in FIG. 4D in the fourth sub-frame.

For the first sub-frame, the color wheel 120 is set for the G filter section 121G1, and the ray position control section 300 is controlled to direct the projection light at the pixel positions a on the screen. Further, the light modulating device 200 is supplied with image information on G images at the pixel positions a. As a result, in the first sub-frame, the G images are displayed at the pixel positions a as shown in FIG. 4A.

For the second sub-frame, the color wheel 120 is set for the R filter section 121R, and the ray position control section 300 is controlled to direct the projection light at the pixel positions b on the screen. Further, the light modulating device 200 is supplied with image information on R images at the pixel positions b. As a result, in the second sub-frame, the R images are displayed at the pixel positions b as shown in FIG. 4B.

For the third sub-frame, the color wheel 120 is set for the G filter section 121G2, and the ray position control section 300 is controlled to direct the projection light at the pixel positions d on the screen. Further, the light modulating device 200 is supplied with image information on G images at the pixel positions d. As a result, in the third sub-frame, the G images are displayed at the pixel positions d as shown in FIG. 4C.

For the fourth sub-frame, the color wheel 120 is set for the B filter section 121B, and the ray position control section 300 is controlled to direct the projection light at the pixel positions c on the screen. Further, the light modulating device 200 is supplied with image information on B images at the pixel positions c. As a result, in the fourth sub-frame, the B images are displayed at the pixel positions c as shown in FIG. 4D.

As described above, in the first sub-frame, the G images are displayed at the pixel positions a. In the second sub-frame, the R images are displayed at the pixel positions b. In the third sub-frame, the G images are displayed at the pixel positions d. In the fourth sub-frame, the B images are displayed at the pixel positions c. As a result, for one frame as a whole, the images in the first to fourth sub-frames are synthesized in the direction of a time axis. A display state with a four-point pixel shift is obtained as shown in FIG. 5. The arrangement state shown in FIG. 5 is similar to a Bayer pattern widely used for imaging devices such as digital cameras. As is apparent from FIG. 5, the number of pixels displayed for G images is twice as large as that of pixels displayed for R or B images. Human eyes have a high spectral luminous efficacy for green (G). Thus, an increase in the number of pixels displayed for G images improves a resolution for human eyes.

In FIGS. 3, 4A to 4D, and 5, for description, the aperture ratio of each pixel is reduced so as to prevent the pixels from overlapping. However, the aperture ratio of each pixel may be increased to the degree that for example, the adjacent pixels overlap in FIG. 5.

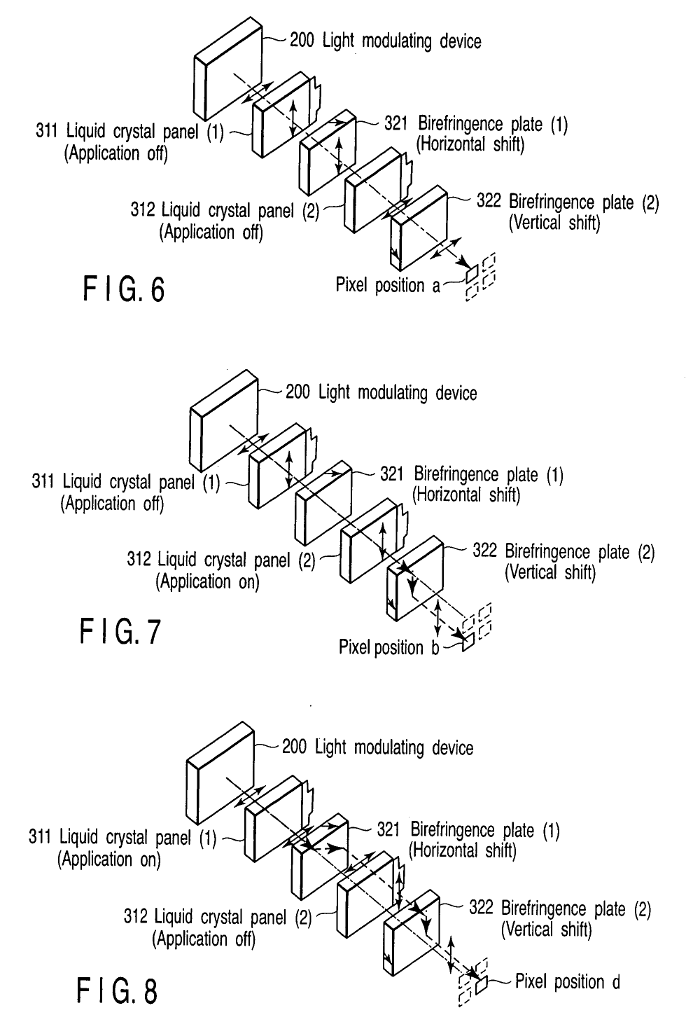

FIGS. 6 to 9 are diagrams showing a shift operation performed by the ray position control section 300, in detail. Display states such as those shown in FIGS. 4A to 4D are obtained by the ray position control section 300 by performing a shift operation as described below.

FIG. 6 is a diagram showing the state of a light ray observed when the polarization rotatable liquid crystal panel (first liquid crystal panel) 311 is set in an off state, while the polarization rotatable liquid crystal panel (second liquid crystal panel) 312 is set in an off state. Light rays emitted by the light modulating device 200 are rotated by the first liquid crystal panel (polarization rotatable liquid crystal panel 311) through 90° and then enter the first birefringence plate (birefringence plate 321). The light rays incident on the first birefringence plate act as ordinary light and pass through the first birefringence plate without being shifted. The light rays then enter the second liquid crystal panel (polarization rotatable liquid crystal panel 312). The light rays incident on the second liquid crystal panel are rotated by the second liquid crystal panel through 90° and then enter the second birefringence plate (birefringence plate 322). The light rays incident on the second birefringence plate act as ordinary light and pass through the second birefringence plate without being shifted. The light rays thus reach the pixel positions a to establish such a display state as shown in FIG. 4A.

FIG. 7 is a diagram showing the state of a light ray observed when the polarization rotatable liquid crystal panel (first liquid crystal panel) 311 is set in the off state, while the polarization rotatable liquid crystal panel (second liquid crystal panel) 312 is set in the on state. Light rays emitted by the light modulating device 200 are rotated by the first liquid crystal panel through 90° and then enter the first birefringence plate. The light rays incident on the first birefringence plate act as ordinary light and pass through the first birefringence plate without being shifted. The light rays then enter the second liquid crystal panel. The light rays incident on the second liquid crystal panel enter the second birefringence plate without being rotated by the second liquid crystal panel. The light rays incident on the second birefringence plate act as extraordinary light and pass through the second birefringence plate after being shifted in the vertical direction. The light rays thus reach the respective pixel positions b to establish such a display state as shown in FIG. 4B.

FIG. 8 is a diagram showing the state of a light ray observed when the polarization rotatable liquid crystal panel (first liquid crystal panel) 311 is set in the on state, while the polarization rotatable liquid crystal panel (second liquid crystal panel) 312 is set in the off state. Light rays emitted by the light modulating device 200 enter the first birefringence plate without being rotated by the first liquid panel. The light rays incident on the first birefringence plate act as extraordinary light and pass through the first birefringence plate after being shifted in the horizontal direction. The light rays then enter the second liquid crystal panel. The light rays incident on the second liquid crystal panel are rotated by the second liquid crystal panel through 90° and then enter the second birefringence plate. The light rays incident on the second birefringence plate act as extraordinary light and pass through the second birefringence plate after being shifted in the vertical direction. The light rays thus reach the respective pixel positions d to establish such a display state as shown in FIG. 4C.

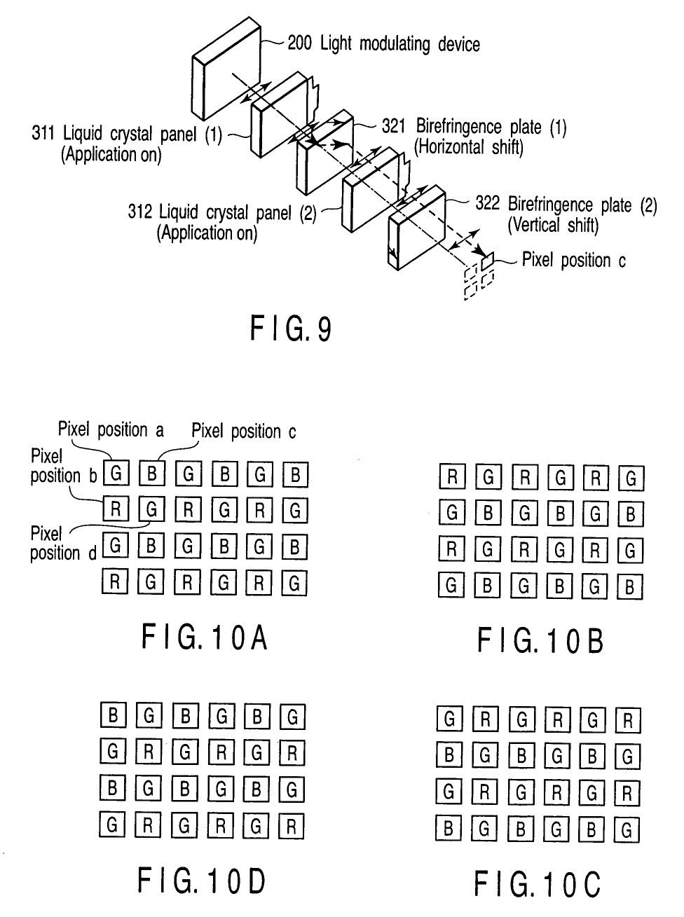

FIG. 9 is a diagram showing the state of a light ray observed when the polarization rotatable liquid crystal panel (first liquid crystal panel) 311 is set in the on state, while the polarization rotatable liquid crystal panel (second liquid crystal panel) 312 is set in the on state. Light rays emitted by the light modulating device 200 enter the first birefringence plate without being rotated by the first liquid crystal panel. The light rays incident on the first birefringence plate act as extraordinary light and pass through the first birefringence plate after being shifted in the horizontal direction. The light rays then enter the second liquid crystal panel. The light rays incident on the second liquid crystal panel enter the second birefringence plate without being rotated by the second liquid crystal panel. The light rays incident on the second birefringence plate act as ordinary light and pass through the second birefringence plate without being shifted. The light rays thus reach the respective pixel positions c to establish such a display state as shown in FIG. 4D.

In the above description, for easy understanding, the G images are displayed at the pixel positions a and d, the R images are displayed at the pixel positions b, and the B images are displayed at the pixel positions c, as shown in FIGS. 4A to 4D. However, if all the frames had the above display states, the same color would be always displayed at each pixel position, resulting in what is called false colors. Thus, in the present embodiment, false colors are prevented by varying the correspondences between the pixel positions and the image colors depending on the frames. FIGS. 10A to 10D show an example of such correspondences.

In the first frame, as shown in FIG. 10A, G images are displayed at pixel positions a and d, R images are displayed at pixel positions b, and B images are displayed at pixel positions c. In the second frame, as shown in FIG. 10B, R images are displayed at positions a, G images are displayed at pixel positions b and c, and B images are displayed at pixel positions d. In the third frame, as shown in FIG. 10C, G images are displayed at pixel positions a and d, B images are displayed at pixel positions b, and R images are displayed at pixel positions c. In the fourth frame, as shown in FIG. 10D, B images are displayed at positions a, G images are displayed at pixel positions b and c, and R images are displayed at pixel positions d.

In this manner, at each pixel position a, the image is displayed in the order of G, R, G, and B. At each pixel position b, the image is displayed in the order of R, G, B, and G. At each pixel position c, the image is displayed in the order of B, G, R, and G. At each pixel position d, the image is displayed in the order of G, B, G, and R. All of the R, G, and B images are displayed at each pixel position by varying the correspondences between the pixel positions and the image colors according to the frames. This prevents the same color from being always displayed at each pixel position. Therefore, the occurrence of false colors can be prevented.

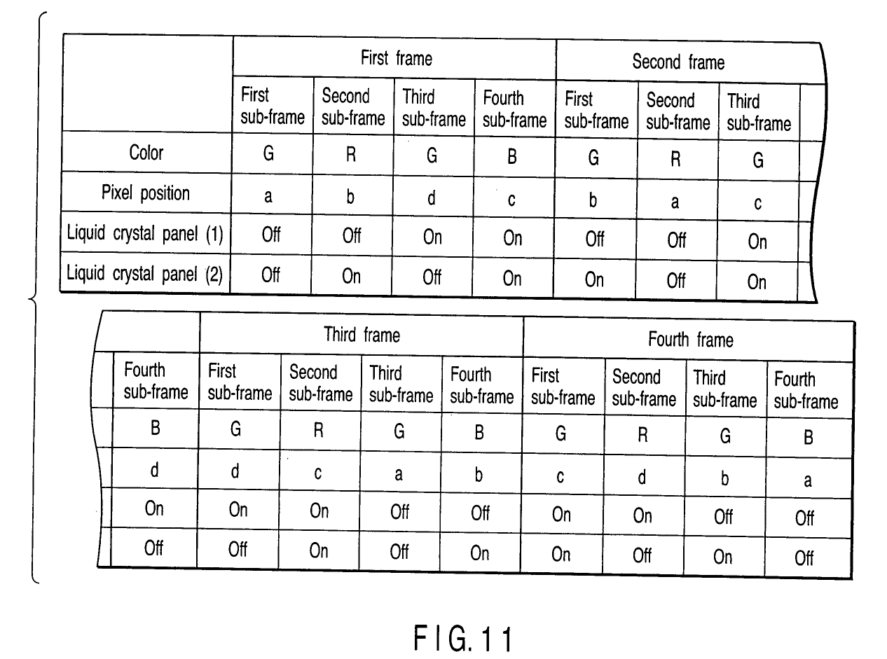

FIG. 11 is a diagram showing the flow, in the time axis direction, of an operation of providing display as shown in FIGS. 10A to 10D.

For a first sub-frame of the first frame, the color of the color wheel 120 is set for green (G), the polarization rotatable liquid crystal panel (first liquid crystal panel) 311 is set in the off state, and the polarization rotatable liquid crystal panel (second liquid crystal panel) 312 is set in the off state. Further, the light modulating device 200 is supplied with image information on the G images at the pixel positions a.

For a second sub-frame of the first frame, the color of the color wheel 120 is set for red (R), the first liquid crystal panel is set in the off state, and the second liquid crystal panel is set in the on state. Further, the light modulating device 200 is supplied with image information on the R images at the pixel positions b.

For a third sub-frame of the first frame, the color of the color wheel 120 is set for green (G), the first liquid crystal panel is set in the on state, and the second liquid crystal panel is set in the off state. Further, the light modulating device 200 is supplied with image information on the G images at the pixel positions d.

For a fourth sub-frame of the first frame, the color of the color wheel 120 is set for blue (B), the first liquid crystal panel is set in the on state, and the second liquid crystal panel is set in the on state. Further, the light modulating device 200 is supplied with image information on the B images at the pixel positions c.

In this manner, in the first frame, the G images are displayed at the pixel positions a and d, the R images are displayed at the pixel positions b, and the B images are displayed at the pixel positions c, as shown in FIG. 10A.

For a first sub-frame of the second frame, the color of the color wheel 120 is set for G, the first liquid crystal panel is set in the off state, and the second liquid crystal panel is set in the on state. Further, the light modulating device 200 is supplied with image information on the G images at the pixel positions b.

For a second sub-frame of the second frame, the color of the color wheel 120 is set for R, the first liquid crystal panel is set in the off state, and the second liquid crystal panel is set in the off state. Further, the light modulating device 200 is supplied with image information on the R images at the pixel positions a.

For a third sub-frame of the second frame, the color of the color wheel 120 is set for G, the first liquid crystal panel is set in the on state, and the second liquid crystal panel is set in the on state. Further, the light modulating device 200 is supplied with image information on the G images at the pixel positions c.

For a fourth sub-frame of the second frame, the color of the color wheel 120 is set for B, the first liquid crystal panel is set in the on state, and the second liquid crystal panel is set in the off state. Further, the light modulating device 200 is supplied with image information on the B images at the pixel positions d.

In this manner, in the second frame, the R images are displayed at the pixel positions a, the G images are displayed at the pixel positions b and c, and the B images are displayed at the pixel positions d, as shown in FIG. 10B.

For a first sub-frame of the third frame, the color of the color wheel 120 is set for G, the first liquid crystal panel is set in the on state, and the second liquid crystal panel is set in the off state. Further, the light modulating device 200 is supplied with the image information on the G images at the pixel positions d.

For a second sub-frame of the third frame, the color of the color wheel 120 is set for R, the first liquid crystal panel is set in the on state, and the second liquid crystal panel is set in the on state. Further, the light modulating device 200 is supplied with the image information on the R images at the pixel positions c.

For a third sub-frame of the third frame, the color of the color wheel 120 is set for G, the first liquid crystal panel is set in the off state, and the second liquid crystal panel is set in the off state. Further, the light modulating device 200 is supplied with the image information on the G images at the pixel positions a.

For a fourth sub-frame of the third frame, the color of the color wheel 120 is set for B, the first liquid crystal panel is set in the off state, and the second liquid crystal panel is set in the on state. Further, the light modulating device 200 is supplied with the image information on the B images at the pixel positions b.

In this manner, in the third frame, the G images are displayed at the pixel positions a and d, the B images are displayed at the pixel positions b, and the R images are displayed at the pixel positions c, as shown in FIG. 10C.

For a first sub-frame of the fourth frame, the color of the color wheel 120 is set for G, the first liquid crystal panel is set in the on state, and the second liquid crystal panel is set in the on state. Further, the light modulating device 200 is supplied with the image information on the G images at the pixel positions c.

For a second sub-frame of the fourth frame, the color of the color wheel 120 is set for R, the first liquid crystal panel is set in the on state, and the second liquid crystal panel is set in the off state. Further, the light modulating device 200 is supplied with the image information on the R images at the pixel positions d.

For a third sub-frame of the fourth frame, the color of the color wheel 120 is set for G, the first liquid crystal panel is set in the off state, and the second liquid crystal panel is set in the on state. Further, the light modulating device 200 is supplied with the image information on the G images at the pixel positions b.

For a fourth sub-frame of the fourth frame, the color of the color wheel 120 is set for B, the first liquid crystal panel is set in the off state, and the second liquid crystal panel is set in the off state. Further, the light modulating device 200 is supplied with the image information on the B images at the pixel positions a.

In this manner, in the fourth frame, the B images are displayed at the pixel positions a, the G images are displayed at the pixel positions b and c, and the R images are displayed at the pixel positions d, as shown in FIG. 10D.

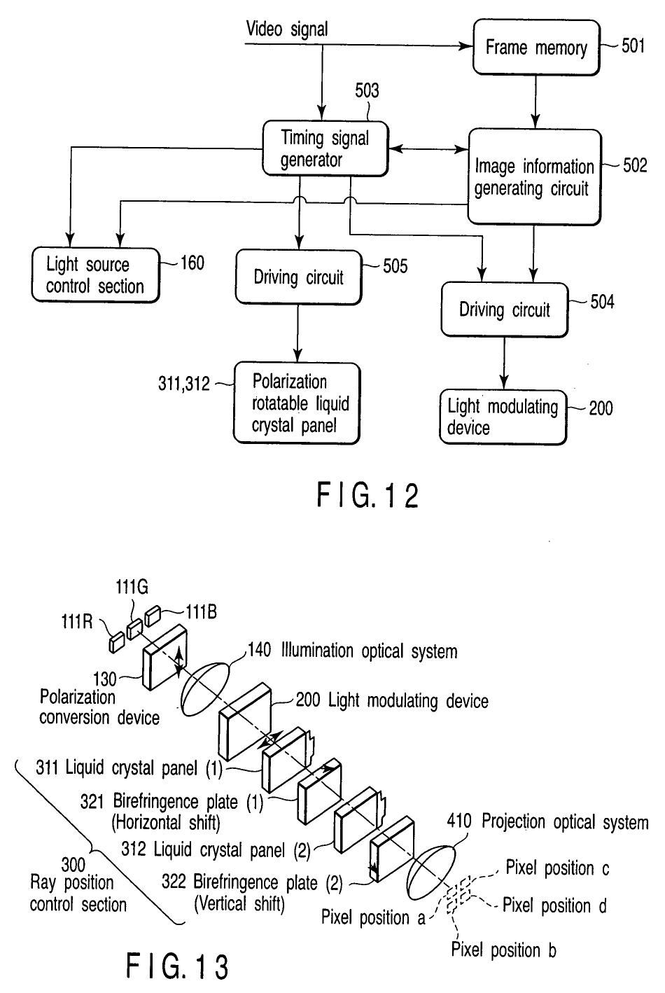

FIG. 12 is a block diagram showing a configuration used to realize such display as described above (four-point pixel shift display) in the above color display apparatus.

Image data contained in an input video signal is stored in a frame memory 501. An image information generating circuit 502 extracts (samples) signal components (R, G, and B signal components) corresponding to the pixel positions a, b, c, and d, from the video signal stored in the frame memory 501.

On the basis of a timing signal from a timing signal generator 503, for example, for the first sub-frame of the first frame, the image data on G at the pixel positions a is supplied to a driving circuit 504. The light modulating device 200 displays the G images. Further, on the basis of a timing signal from the timing signal generator 503, a driving circuit 505 controls the polarization rotatable liquid crystal panels 311 and 312 in synchronism with driving timings (display timings) for the light modulating device 200. Moreover, on the basis of a timing signal from the timing signal generator 503, the light source control section 160 sets the color of the color wheel 120 for G in synchronism with driving timings (display timings) for the light modulating device 200. Similar operations are performed for the other frames and sub-frames to realize such display as shown in FIGS. 10A to 10D. The light source control section 160 controls not only the color wheel 120 but also the liquid crystal shutter 150 to adjust white balance and the like.

As described above, according to the present embodiment, images are displayed at all the pixel positions in each frame as shown in FIGS. 4A to 4D. Thus, a basic pixel shift effect is exerted during a short period (one-frame period). Further, the positional relationship between the R images and the G images and the B images varies with the frames as shown in FIGS. 10A to 10D. Thus, displaying a four-frame period enables all of the R, G, and B images to be displayed at each pixel position. This makes it possible to prevent the occurrence of false colors. Therefore, color images of a high resolution and high quality can be obtained.

Further, in the present embodiment, the number of times the G images, which have a higher spectral luminous efficacy, are displayed is twice as large as that the R or B images are displayed. Accordingly, the higher resolution can be recognized. Furthermore, in the present embodiment, the G images are displayed in a diagonal direction. Moreover, the G images are displayed between the period in which the R images are displayed and the period in which the B images are displayed. This inhibits the G images from being consecutively displayed within one-frame period. Therefore, also in this point, display quality can be improved.

### Embodiment 2

FIG. 13 is a diagram schematically showing a color image projection apparatus (color display apparatus) according to a second embodiment of the present invention.

In the first embodiment, the light source 110, the color wheel 120, and the like are used to generate R, G, and B illumination light. However, in the present embodiment, an R, G, and B LEDs are used to generate illumination light. The remaining part of the basic configuration of the present embodiment is similar to that of the first embodiment. Components of the present embodiment which correspond to those of the first embodiment are denoted by the same reference numerals. Their detailed description is omitted.

In the present embodiment, a light source includes an R (red) light LED 111R, a G (green) light LED 11G, and a B (blue) light LED 111B. A light source control section (corresponding to the light source control section 160 in FIG. 12) controls emissions from LED111R, LED111G, and LED111B. That is, the present embodiment controls emission timings for the LED111R, LED111G, and LED111B and ray shift timings for the polarization rotatable liquid crystal panels 311 and 312 in synchronism with display timings for the light modulating device 200. This makes it possible to realize display states similar to those in the first embodiment. However, according to the present embodiment, LED111R, LED111G, and LED111B are placed at different positions, so that an emission position of the light source varies depending on the colors. Thus, the illumination optical system 140 is configured to inhibit the light modulating device 200 from being unevenly illuminated.

According to the first embodiment, the order of colors of illumination light is unitarily determined because the color of the illumination light is varied by rotating the color wheel 120. The present embodiment uses LEDs so that the order of colors of illumination light can be varied on the basis of the order of emissions from LED111R, LED111G, and LED111B. Further, the present embodiment makes it possible to easily vary the emission time (emission period) or intensity of each of LED111R, LED111G, and LED111B. Thus, by using the light source control section (corresponding to the light source control section 160 in FIG. 12) to control the emissions from LED111R, LED111G, and LED111B, it is possible to easily adjust white balance or the like even without the liquid crystal shutter 150, shown in the first embodiment.

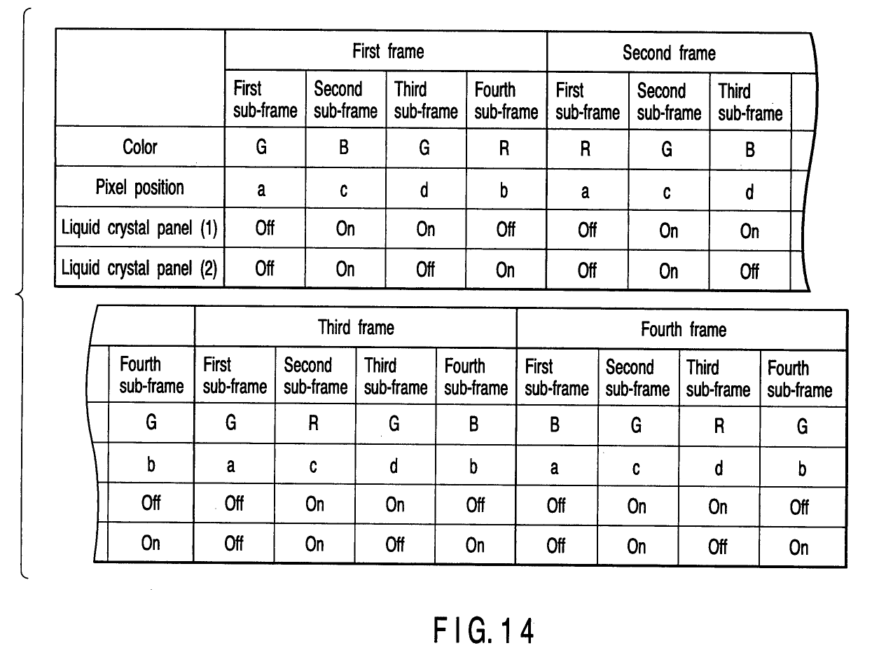

FIG. 14 is a diagram showing the flow of the display state in the time axis direction according to the present embodiment. In the first embodiment, the use of the color wheel makes the order of colors of the illumination light fixed regardless of the frames as shown in FIG. 11. In the present embodiment, the order of colors of the illumination light is varied with the frames by varying the order of emissions from LEDs. That is, according to the present embodiment, the correspondences between the pixel positions and the image colors are varied with the frames by varying the order of emissions from LEDs. This prevents the occurrence of false colors. Specific operations in FIG. 14 will be described below.

For the first sub-frame of the first frame, LED111G is caused to emit light, and the polarization rotatable liquid crystal panel (first liquid crystal panel) 311 is set in the off state, and the polarization rotatable liquid crystal panel (second liquid crystal panel) 312 is set in the off state. Further, the light modulating device 200 is supplied with image information on the G images at the pixel positions a.

For the second sub-frame of the first frame, LED111B is caused to emit light, and the first liquid crystal panel is set in the on state, and the second liquid crystal panel is set in the on state. Further, the light modulating device 200 is supplied with the image information on the B images at the pixel positions c.

For the third sub-frame of the first frame, LED111G is caused to emit light, and the first liquid crystal panel is set in the on state, and the second liquid crystal panel is set in the off state. Further, the light modulating device 200 is supplied with the image information on the G images at the pixel positions d.

For the fourth sub-frame of the first frame, LED111R is caused to emit light, and the first liquid crystal panel is set in the off state, and the second liquid crystal panel is set in the on state. Further, the light modulating device 200 is supplied with the image information on the R images at the pixel positions b.

In this manner, for the first frame, LEDs emit light in the order of G, B, G, and R so that the G images are displayed at the pixel positions a and d, the R images are displayed at the pixel positions b, and the B images are displayed at the pixel positions c. As a result, such a display state as shown in FIG. 10A is obtained.

For the second frame, LEDs emit light in the order of R, G, B, and G so that the R images are displayed at the pixel positions a, the G images are displayed at the pixel positions b and c, and the B images are displayed at the pixel positions d. As a result, such a display state as shown in FIG. 10B is obtained.

For the third frame, LEDs emit light in the order of G, R, G, and B so that the G images are displayed at the pixel positions a and d, the B images are displayed at the pixel positions b, and the R images are displayed at the pixel positions c. As a result, such a display state as shown in FIG. 10C is obtained.

For the fourth frame, LEDs emit light in the order of B, G, R, and G so that the B images are displayed at the pixel positions a, the G images are displayed at the pixel positions b and c, and the R pixels are displayed at the pixel positions d. As a result, such a display state as shown in FIG. 10D is obtained.

As described above, like the first embodiment, the present embodiment makes it possible to provide color images of a high resolution and high quality. Further, the use of LEDs as a light source enables the order of colors of the illumination light to be easily varied according to the frames. It is also possible to easily set the desired display state (the correspondences between the pixel positions and the image colors) for each frame. The use of LEDs as a light source enables the emission period or intensity to be easily varied. This makes it possible to easily carry out, for example, adjustment of white balance.

### Embodiment 3

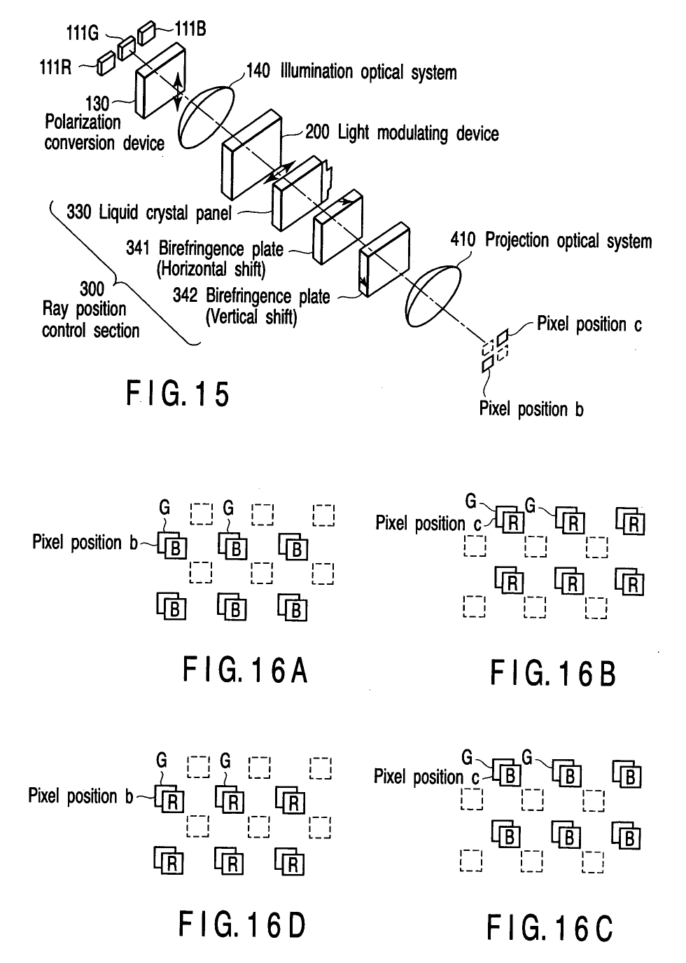

FIG. 15 is a diagram schematically showing a color image projection apparatus (color display apparatus) according to a third embodiment of the present invention.

In the first and second embodiments, four-point pixel shift display is provided by using the two polarization rotatable liquid crystal panels 311 and 312 and the two birefringence plates 321 and 322 as the ray position control section 300. In the present embodiment, two-point pixel shift display is provided by using one polarization rotatable liquid crystal panel 330 and two birefringence plate 341 and 342 as the ray position control section 300. The remaining part of the basic configuration of the present embodiment is similar to those of the first and second embodiments. Components of the present embodiment which correspond to those of the first and embodiments are denoted by the same reference numerals. Their detailed description is omitted.

LEDs are used as means for supplying the light modulating device 200 with R, G, and B illumination light as in the case of the second embodiment. However, a color wheel or the like may be used as in the case of the first embodiment. Further, in the example described below, a two-point pixel shift in an oblique direction is carried out. However, it is possible to carry out a two-point pixel shift in the horizontal or vertical direction.

FIGS. 16A to 16D are diagrams showing the display state on the projection surface (screen surface) which state varies depending on the shift state controlled by the ray position control section 300. The pixel array in the transmission LCD constituting the light modulating device 200 is similar to that shown in FIG. 3. In FIGS. 16A to 16D, for description, two display pixels are drawn to be offset from each other at each pixel position. However, the two display pixels are actually located at the same position.

In the present embodiment, the process described below is used to establish the display state shown in FIG. 16A in the first and second sub-frames of the first frame, the display state shown in FIG. 16B in the third and fourth sub-frames of the first frame, the display state shown in FIG. 16C in the first and second sub-frames of the second frame, and the display state shown in FIG. 16D in the third and fourth sub-frames of the second frame.

For the first and second sub-frames of first frame, the ray position control section 300 is controlled so that projection light is projected at the pixel positions b on the screen. For the first sub-frame, LED111G is caused to emit light, and the light modulating device 200 is supplied with the image information on the G images at the pixel positions b. For the second sub-frame, LED111B is caused to emit light, and the light modulating device 200 is supplied with the image information on the B images at the pixel positions b. As a result, as shown in FIG. 16A, in the first sub-frame of the first frame, the G images are displayed at the pixel positions b. In the second sub-frame of the first frame, the B images are displayed at the pixel positions b.

For the third and fourth sub-frames of first frame, the ray position control section 300 is controlled so that projection light is projected at the pixel positions c on the screen. For the third sub-frame, LED111G is caused to emit light, and the light modulating device 200 is supplied with the image information on the G images at the pixel positions c. For the fourth sub-frame, LED111R is caused to emit light, and the light modulating device 200 is supplied with the image information on the R images at the pixel positions c. As a result, as shown in FIG. 16B, in the third sub-frame of the first frame, the G images are displayed at the pixel positions c. In the fourth sub-frame of the first frame, the R images are displayed at the pixel positions c.

For the first and second sub-frames of second frame, the ray position control section 300 is controlled so that projection light is projected at the pixel positions c on the screen. For the first sub-frame, LED111G is caused to emit light, and the light modulating device 200 is supplied with the image information on the G images at the pixel positions c. For the second sub-frame, LED111B is caused to emit light, and the light modulating device 200 is supplied with the image information on the B images at the pixel positions c. As a result, as shown in FIG. 16C, in the first sub-frame of the second frame, the G images are displayed at the pixel positions c. In the second sub-frame of the second frame, the B images are displayed at the pixel positions c.

For the third and fourth sub-frames of second frame, the ray position control section 300 is controlled so that projection light is projected at the pixel positions b on the screen. For the third sub-frame, LED111G is caused to emit light, and the light modulating device 200 is supplied with the image information on the G images at the pixel positions b. For the fourth sub-frame, LED111R is caused to emit light, and the light modulating device 200 is supplied with the image information on the R images at the pixel positions b. As a result, as shown in FIG. 16D, in the third sub-frame of the second frame, the G images are displayed at the pixel positions b. In the fourth sub-frame of the second frame, the R images are displayed at the pixel positions b.

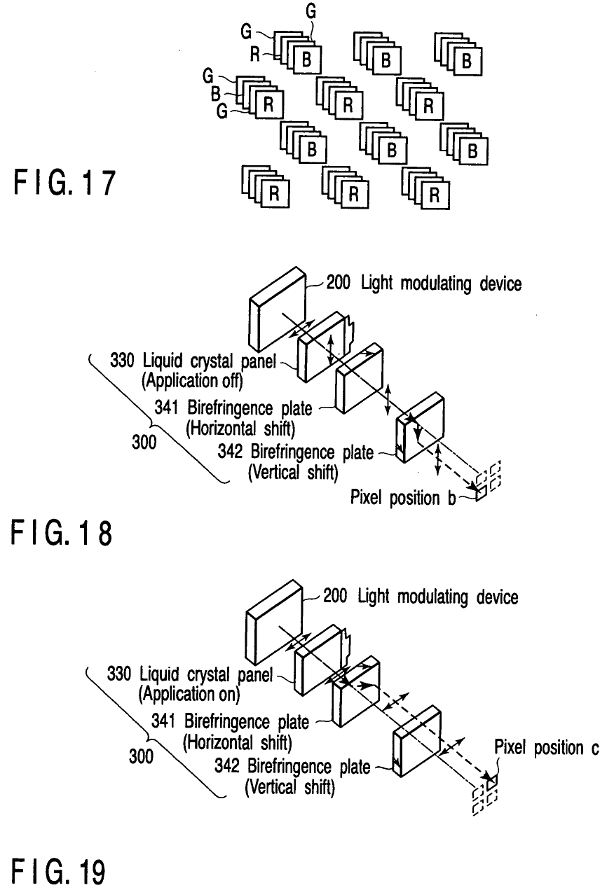

As described above, according to the present embodiment, for one-frame period, the synthesized images each of the G and B images are displayed diagonally to the synthesized images each of the G and R images. Consequently, two-point pixel shift display in the diagonal direction (oblique direction) is provided within one-frame period. Further, in the first frame, each synthesized image of the G and B images is displayed at the pixel position b, and each synthesized image of the G and R images is displayed at the pixel position c. In contrast, in the second frame, the each synthesized image of the G and B images is displayed at the pixel position c, and each synthesized image of the G and R images is displayed at the pixel position b. Thus, for two-frame period, all of the R, G, and B images are displayed at each of the pixel positions b and c. As a result, full-color two-point pixel shift display is realized as shown in FIG. 17. In FIG. 17, for description, four display pixels are drawn to be offset from each other at each pixel position. However, the four display pixels are actually located at the same position.

FIGS. 18 and 19 are diagrams showing, in detail, a shift operation performed by the ray position control section 300. The ray position control section 300 performs a shift operation as described below to establish such display states as shown in FIGS. 16A to 16D.

FIG. 18 is a diagram showing the state of light rays observed when the polarization rotatable liquid crystal panel 330 is set in the off state. Light rays emitted by the light modulating device 200 are rotated by the liquid crystal panel 330 through 90° and then enter the birefringence plate 341. The light rays incident on the birefringence plate 341 act as ordinary light and pass through the birefringence plate 341 without being shifted and then enter the birefringence plate 342. The light rays incident on the birefringence plate 342 act as extraordinary light and is shifted in the vertical direction. The light rays pass through the birefringence plate 342. In this manner, the light rays reach the pixel positions b. As a result, in the first and second sub-frames of the first frame, such a display state as shown in FIG. 16A is established. Likewise, in the third and fourth sub-frames of the second frame, such a display state as shown in FIG. 16D is established.

FIG. 19 is a diagram showing the state of light rays observed when the polarization rotatable liquid crystal panel 330 is set in the on state. Light rays emitted by the light modulating device 200 enter the birefringence plate 341 without being rotated by the liquid crystal panel 330. The light rays incident on the birefringence plate 341 act as extraordinary light and is shifted in the horizontal direction. The light rays pass through the birefringence plate 341 and then enter the birefringence plate 342. The light rays incident on the birefringence plate 342 act as ordinary light and pass through the birefringence plate 342 without being shifted. In this manner, the light rays reach the pixel positions c. As a result, in the third and fourth sub-frames of the first frame, such a display state as shown in FIG. 16B is established. Likewise, in the first and second sub-frames of the second frame, such a display state as shown in FIG. 16C is established.

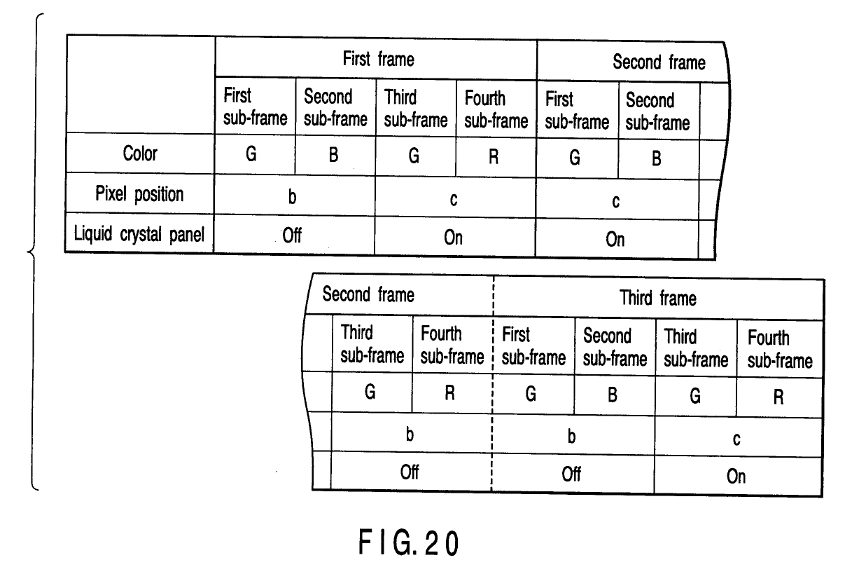

FIG. 20 is a diagram of the flow, in the time axis direction, of operations performed to provide such display as shown in FIG. 17.

For the first and second sub-frames of the first frame, the polarization rotatable liquid crystal panel 330 is set in the off state. For the first sub-frame, LED111G is caused to emit light, and the light modulating device 200 is supplied with the image information on the G images at the pixel positions b. For the second sub-frame, LED111B is caused to emit light, and the light modulating device 200 is supplied with the image information on the B images at the pixel positions b.

For the third and fourth sub-frames of the first frame, the polarization rotatable liquid crystal panel 330 is set in the on state. For the third sub-frame, LED111G is caused to emit light, and the light modulating device 200 is supplied with the image information on the G images at the pixel positions c. For the fourth sub-frame, LED111R is caused to emit light, and the light modulating device 200 is supplied with the image information on the R images at the pixel positions c.

For the first and second sub-frames of the second frame, the polarization rotatable liquid crystal panel 330 is set in the on state. For the first sub-frame, LED111G is caused to emit light, and the light modulating device 200 is supplied with the image information on the G images at the pixel positions c. For the second sub-frame, LED111B is caused to emit light, and the light modulating device 200 is supplied with the image information on the B images at the pixel positions c.

For the third and fourth sub-frames of the second frame, the polarization rotatable liquid crystal panel 330 is set in the off state. For the third sub-frame, LED111G is caused to emit light, and the light modulating device 200 is supplied with the image information on the G images at the pixel positions b. For the fourth sub-frame, LED111R is caused to emit light, and the light modulating device 200 is supplied with the image information on the R images at the pixel positions b.

These operations are repeated for the subsequent frames. Thus, such a two-point pixel shift color image as shown in FIG. 17 is displayed on the screen.

As described above, according to the present embodiment, the two pixel positions (pixel positions b and c) present in the diagonal direction are used for display in each frame. Thus, a basic pixel shift effect is exerted during a short period (one-frame period). Further, the positional relationship between the R images and the G images and the B images varies with the frames as seen in FIGS. 16A and 16B and in FIGS. 16C and 16D. Accordingly, display for two-frame period enables all of the R, G, and B images to be displayed at each pixel position. This makes it possible to prevent the occurrence of false colors. Therefore, color images of a high resolution and high quality can be obtained.

Further, in the present embodiment, the number of times the G images, having a higher spectral luminous efficacy, are displayed is twice as large as that the R or B images are displayed. Moreover, the G images are displayed between the period in which the R images are displayed and the period in which the B images are displayed. This inhibits the G images from being consecutively displayed within one-frame period. Therefore, also in this point, display quality can be improved.

Further, the two-point pixel shift display uses two frames as one period to enhance the effect of synthesizing images in the time axis direction. Furthermore, the two-point pixel shift, carried out in the oblique direction, is inferior to the four-point pixel shift in the resolution in the oblique direction but can provide a resolution comparable to that of the four-point pixel shift in the horizontal and vertical direction. Therefore, images of a high resolution can be obtained using a configuration simpler than that based on the four-point pixel shift display.

### Embodiment 4

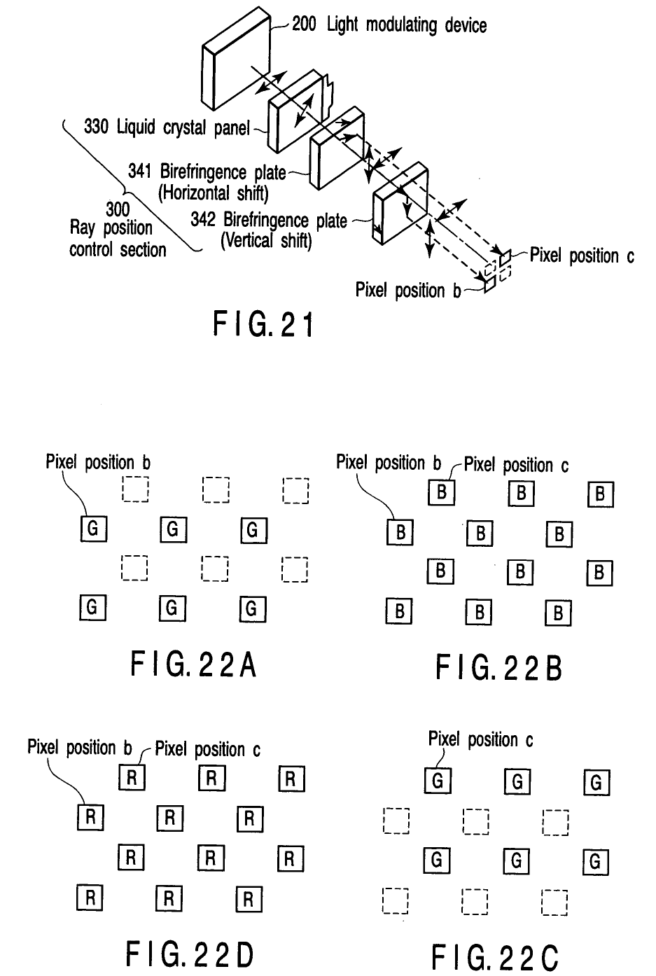

FIG. 21 is a diagram schematically showing a color image projection apparatus (color display apparatus) according to a fourth embodiment of the present invention. Only the ray position control section 300 is drawn in FIG. 21. However, the basic configuration of the whole apparatus is similar to that shown in FIG. 15 for the third embodiment.

Like the third embodiment, the present embodiment provides two-point pixel shift display by using the one polarization rotatable liquid crystal panel 330 and the two birefringence plate 341 and 342 as the ray position control section 300. However, the operation of the polarization rotatable liquid crystal panel 330 according to the present embodiment differs from that according to the third embodiment as described below.

In the present embodiment, the polarization rotatable liquid crystal panel 330 is set not only in the on or off state but also in a half tone state (half tone on state) between on state and off state. In the half tone state, a predetermined intermediate voltage between the on voltage and the off voltage is applied to the polarization rotatable liquid crystal panel 330. As a result, polarized light emitted by the light modulating device 200 is rotated by the polarization rotatable liquid crystal panel 330 through substantially 45°. The resultant polarized light has a polarization transmission axis in the vertical direction and a polarization transmission axis in the horizontal direction. The polarized light then enters the birefringence plate 341. Of the polarized light incident on the birefringence plate 341, the light rays of the polarized light having the polarization transmission axis in the vertical direction pass through the birefringence plate 341 without being shifted. The light rays of the polarized light having the polarization transmission axis in the horizontal direction are shifted in the horizontal direction and pass through the birefringence plate 341. Of the polarized light having passed through the birefringence plate 341, the light rays of the polarized light having the polarization transmission axis in the vertical direction are shifted in the vertical direction and pass through the birefringence plate 342. The light rays of the polarized light having the polarization transmission axis in the horizontal direction pass through the birefringence plate 342 without being shifted. In this manner, the light rays of the polarized light having the polarization transmission axis in the vertical direction reach the pixel positions b on the projection surface. The light rays of the polarized light having the polarization transmission axis in the horizontal direction reach the pixel positions c on the projection surface.

When the voltage between the on and off voltages is applied to the polarization rotatable liquid crystal panel 330, the light rays emitted by the light modulating device 200 always reach the pixel positions b and c. However, the ratio of the light intensity at the pixel positions b to the light intensity at the pixel positions c varies according to the value of the voltage applied to the polarization rotatable liquid crystal panel 330. Therefore, in the present embodiment, the polarization rotatable liquid crystal panel 330 is subjected to such a voltage as makes the light intensity at the pixel positions b equal to that at the pixel positions c.

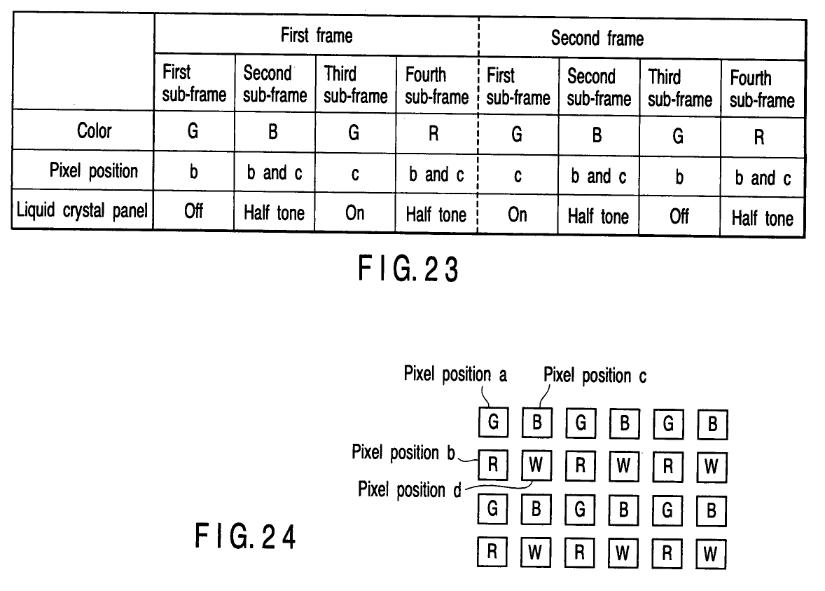

The operation of the present embodiment will be described below in detail with reference to FIGS. 22A to 22D and 23. FIGS. 22A to 22D are diagrams showing the pixel array on the projection surface (screen surface) which results from projection light varying with the shift state controlled by the ray position control section 300. The pixel array on the transmission LCD constituting the light modulating device 200 is similar to that shown in FIG. 3. FIG. 23 is a diagram of the flow, in the time axis direction, of operations performed to provide such display as shown in FIGS. 22A to 22D.

For the first sub-frame of the first frame, LED111G (see FIG. 15) is caused to emit light, and the polarization rotatable liquid crystal panel 330 is set in the off state. Further, the light modulating device 200 is supplied with the image information on the G images at the pixel positions b. As a result, as shown in FIG. 22A, the G images are displayed at the pixel positions b on the screen surface.

For the second sub-frame of the first frame, LED111B (see FIG. 15) is caused to emit light, and the polarization rotatable liquid crystal panel 330 is set in the half tone state. Further, the light modulating device 200 is supplied with the image information on the B images at the pixel positions b, the image information on the B images at the pixel positions c, or average image information for the image information on the B images at the pixel positions b and the image information on the B images at the pixel positions c (it is desirably supplied with the average image information). As a result, as shown in FIG. 22B, the B images are displayed at the pixel positions b and c on the screen surface.

For the third sub-frame of the first frame, LED111G (see FIG. 15) is caused to emit light, and the polarization rotatable liquid crystal panel 330 is set in the on state. Further, the light modulating device 200 is supplied with the image information on the G images at the pixel positions c. As a result, as shown in FIG. 22C, the G images are displayed at the pixel positions c on the screen surface.

For the fourth sub-frame of the first frame, LED111R (see FIG. 15) is caused to emit light, and the polarization rotatable liquid crystal panel 330 is set in the half tone state. Further, the light modulating device 200 is supplied with the image information on the R images at the pixel positions b, the image information on the R images at the pixel positions c, or average image information for the image information on the R images at the pixel positions b and the image information on the R images at the pixel positions c (it is desirably supplied with the average image information). As a result, as shown in FIG. 22D, the R images are displayed at the pixel positions b and c on the screen surface.

In this manner, in the first sub-frame of the first frame, the G images are displayed at the pixel positions b, and in the second sub-frame, the B images are displayed at the pixel positions b and c. In the third sub-frame, the G images are displayed at the pixel positions c, and in the fourth sub-frame, the R images are displayed at the pixel positions b and c. As a result, an image obtained by synthesizing the displays in FIGS. 22A to 22D in the time axis direction is displayed on the screen.

Almost the same operations as those for the first frame are performed for the second frame. In the first sub-frame, the G images are displayed at the pixel positions c, and in the second sub-frame, the B images are displayed at the pixel positions b and c. In the third sub-frame, the G images are displayed at the pixel positions b, and in the fourth sub-frame, the R images are displayed at the pixel positions b and c. As a result, as in the case of the first frame, an image obtained by synthesizing the displays in FIGS. 22A to 22D in the time axis direction is displayed on the screen.

As described above, according to the present embodiment, during one-sub-frame period, each of the R and B images is simultaneously displayed at the two pixel positions (pixel positions b and c) present in the diagonal direction. As a result, in each frame, all of the R, G, and B images are displayed at each of the two pixel positions (pixel positions b and c) present in the diagonal direction. Consequently, the pixel shift effect is exerted during a short period (one-frame period). Further, the occurrence of false colors can be prevented. Therefore, color images of a high resolution and high quality can be obtained. Further, the number of times the G images, having a higher spectral luminous efficacy, are displayed is twice as large as that of the R or B images are displayed. Moreover, the G images are displayed between the period in which the R images are displayed and the period in which the B images are displayed. Therefore, also in this point, display quality can be improved.

### Embodiment 5

FIG. 24 is a diagram showing the display state on the projection surface (screen surface) obtained by a color image projection apparatus (color display apparatus) according to a fifth embodiment of the present invention. According to the present embodiment, the colors of illumination light supplied to the light modulating device are R (red), G (green), B (blue), and W (white).

Such a configuration as shown in the first or second embodiment may be used as the basic configuration of the whole apparatus. If such a configuration as shown in the first embodiment is used, the color wheel 120, shown in FIGS. 1 and 2, may be provided with an R filter section, a G filter section, and a B filter section, as well as a colorless, transparent W filter section. With such a configuration as shown in the second embodiment, white (W) light can be obtained by simultaneously activating LED111R, which emits red light, LED111G, which emits green light, and LED111B, which emits blue light, all LEDs being shown in FIG. 13.

In the first and second embodiments, the light modulating device 200 is supplied with G illumination light twice and each of R and B illumination lights once during one frame. In the present embodiment, one of the two G illumination lights is replaced with W illumination light. This causes the light modulating device 200 to be supplied with each of R, G, B, and W illumination lights once during one frame. Thus replacing the G illumination light with the W illumination light, it is possible to reduce the level of color break that may occur when the illumination light color is switched.

If the four colors R, G, B, and W are used for illumination light, R and B appear darker than G and W. Thus, when R and B appear consecutively and G and W appear consecutively, the repetitive periods of a dark state and a bright state increase. This makes flickers likely to be perceived. Therefore, each of R and B is preferably located between G and W, as in G, B, W, R, G, B, W, and R.

Like the first and second embodiments, the present embodiment provides color images of a high resolution and high quality.

As described above, in the above embodiments, “one frame” corresponds to a video information period for one screen (for example, 1/60 or 1/30 second). However, the present invention is not limited to this. If the light modulating device or the liquid crystal panel can operate at an increased speed, then for example, the four frames in FIG. 11 may be a video information period for one screen. In other words, the same image information may be displayed four times (four frames). Such quick switched display provides images having less flickers and which are easier to view.

As described above, the present invention can prevent the problems such as the increase in display period and the occurrence of false colors and provides color images of a high resolution and high quality.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A color display apparatus which presents a viewer with a color image based on input image information, the apparatus comprising:
a display section which sequentially displays a plurality of sub-frame images in a plurality of colors based on the input image information to emit projection light;
a ray position control section which controls a ray position of the projection light emitted by the display section, in synchronism with display timings for the sub-frame images; and
an optical section which presents the viewer with the projection light controlled by the ray position control section,
wherein the display section emits the projection light for each pixel of the display section on the basis of the input image information, and
the ray position control section performs control such that the number of ray positions of the projection light emitted by each of the pixels of the display section is M (M is an integer equal to or greater than 2) during one-frame period and performs the control for the one-frame period, over N (N is an integer equal to or greater than 2) frame periods, so that rays of the projection light for all the plurality of colors are located at each of the M ray positions.

2. The color display apparatus according to claim 1, wherein the number M is equal to the number N.

3. The color display apparatus according to claim 1, wherein the plurality of colors are red, green, and blue,
the number N is 4, and
during one-frame period, the display section displays each of a red sub-frame image and a blue sub-frame image once and a green sub-frame image twice.

4. The color display apparatus according to claim 3, wherein the green sub-frame images are not consecutively displayed during the one frame period.

5. The color display apparatus according to claim 1, wherein the plurality of colors are red, green, and blue,
the number N is 2,
during one-frame period, the display section displays each of a red sub-frame image and a blue sub-frame image once and a green sub-frame image twice, and
the ray position control section controls the ray positions of the projection light so that during the one-frame period, the projection light of the red sub-frame image and the projection light of one of the green sub-frame images are located at the same ray position and the projection light of the blue sub-frame image and the projection light of the other green sub-frame image are located at the same ray position.

6. The color display apparatus according to claim 5, wherein the green sub-frame images are not consecutively displayed during the one-frame period.

7. The color display apparatus according to claim 1, wherein the plurality of colors are red, green, blue, and white,
the number N is 4, and
the ray position control section controls the ray positions of the projection light of the red, green, blue, and white sub-frame images emitted by the display section during the one-frame period.

8. The color display apparatus according to claim 1, wherein the ray position control section controls the ray positions of the projection light emitted by the display section so that a resolution of an image recognized by the viewer is N times as high as that of the display section itself.

9. The color display apparatus according to claim 1, wherein the display section comprises:
a white light source which emits white illumination light;
a rotatable color filter which sequentially converts the white illumination light emitted by the white light source into illumination light in the plurality of colors; and
a light modulating device which modulates the illumination light sequentially emitted by the rotatable color filter on the basis of the input image information.

10. The color display apparatus according to claim 1, wherein the display section comprises:
a plurality of LED light sources which sequentially emit illumination light in the plurality of colors; and
a light modulating device which modulates the illumination light sequentially emitted by the LED light sources on the basis of the input image information.

11. The color display apparatus according to claim 1, wherein the ray position control section has a liquid crystal panel which can rotate a direction of polarization of the projection light, and a birefringence plate which generates transmission light shifted from an extension of incident light if the incident light has a particular direction of polarization, and
the liquid crystal panel rotates the direction of polarization of the projection light in synchronism with the display timings for the sub-frame images.

12. A color display apparatus which presents a viewer with a color image based on input image information, the apparatus comprising:
a display section which sequentially displays a plurality of sub-frame images in a plurality of colors based on the input image information to emit projection light;
a ray position control section which controls a ray position of the projection light emitted by the display section, in synchronism with display timings for the sub-frame images; and
an optical section which presents the viewer with the projection light controlled by the ray position control section,
wherein the display section emits the projection light for each pixel of the display section on the basis of the input image information, and
the ray position control section performs control such that the number of ray positions of the projection light emitted by each of the pixels of the display section is M (M is an integer equal to or greater than 2) during one-frame period and such that the number of ray positions of projection light of the sub-frame image in at least one color is twice as large as that of ray positions of projection light of the sub-frame image in the other color, so that rays of the projection light for all the plurality of colors are located at each of the M ray positions.

13. The color display apparatus according to claim 12, wherein the ray position control section has a liquid crystal panel which can rotate a direction of polarization of the projection light in synchronism with the display timings for the sub-frame images, and a birefringence plate which generates transmission light shifted from an extension of incident light if the incident light has a particular direction of polarization, and
the liquid crystal panel rotates the direction of polarization of the projection light through 45° for the at least one color and maintains the direction of polarization of the projection light or rotates the direction of polarization of the projection light through 90° for the other color.

14. The color display apparatus according to claim 12, wherein the display section comprises:
a white light source which emits white illumination light;
a rotatable color filter which sequentially converts the white illumination light emitted by the white light source into illumination light in the plurality of colors; and
a light modulating device which modulates the illumination light sequentially emitted by the rotatable color filter on the basis of the input image information.

15. The color display apparatus according to claim 12, wherein the display section comprises:
a plurality of LED light sources which sequentially emit illumination light in the plurality of colors, and
a light modulating device which modulates the illumination light sequentially emitted by the LED light sources on the basis of the input image information.

16. The color display apparatus according to claim 12, wherein the ray position control section has a liquid crystal panel which can rotate a direction of polarization of the projection light, and a birefringence plate which generates transmission light shifted from an extension of incident light if the incident light has a particular direction of polarization, and
the liquid crystal panel rotates the direction of polarization of the projection light in synchronism with the display timings for the sub-frame images.

17. A color display apparatus which presents a viewer with a color image based on input image information, the apparatus comprising:
display means for sequentially displaying a plurality of sub-frame images in a plurality of colors based on the input image information to emit projection light;
ray position control means for controlling a ray position of the projection light emitted by the display means, in synchronism with display timings for the sub-frame images; and
optical means for presenting the viewer with the projection light controlled by the ray position control means,
wherein the display means emits the projection light for each pixel of the display means on the basis of the input image information, and
the ray position control means performs control such that the number of ray positions of the projection light emitted by each of the pixels of the display means is M (M is an integer equal to or greater than 2) during one-frame period and performs the control for the one-frame period, over N (N is an integer equal to or greater than 2) frame periods, so that rays of the projection light for all the plurality of colors are located at each of the M ray positions.

18. A color display apparatus which presents a viewer with a color image based on input image information, the apparatus comprising:
display means for sequentially displaying a plurality of sub-frame images in a plurality of colors based on the input image information to emit projection light;
ray position control means for controlling a ray position of the projection light emitted by the display means, in synchronism with display timings for the sub-frame images; and
optical means for presenting the viewer with the projection light controlled by the ray position control means,
wherein the display means emits the projection light for each pixel of the display means on the basis of the input image information, and
the ray position control means performs control such that the number of ray positions of the projection light emitted by each of the pixels of the display means is M (M is an integer equal to or greater than 2) during one-frame period and such that the number of ray positions of projection light of the sub-frame image in at least one color is twice as large as that of ray positions of projection light of the sub-frame image in the other color, so that rays of the projection light for all the plurality of colors are located at each of the M ray positions.
